(19) United States
(12) Patent Application Publication
(10) Pub. No.: US 2014/0114493 A1
(43) Pub. Date: Apr. 24, 2014

(54) ENVIRONMENT CONTROL SYSTEM, METHOD FOR PERFORMING THE SAME AND COMPUTER READABLE MEDIUM

(71) Applicants: Takeo TSUKAMOTO, Kanagawa (JP); Takanori Inadome, Kanagawa (JP); Hidenori Tomono, Kanagawa (JP); Yukio Fujiwara, Kanagawa (JP); Kenji Kameyama, Kanagawa (JP); Hideaki Aratani, Kanagawa (JP); Hiroto Higuchi, Kanagawa (JP); Yukiko Oshima, Tokyo (JP)

(72) Inventors: Takeo TSUKAMOTO, Kanagawa (JP); Takanori Inadome, Kanagawa (JP); Hidenori Tomono, Kanagawa (JP); Yukio Fujiwara, Kanagawa (JP); Kenji Kameyama, Kanagawa (JP); Hideaki Aratani, Kanagawa (JP); Hiroto Higuchi, Kanagawa (JP); Yukiko Oshima, Tokyo (JP)

(21) Appl. No.: 14/040,876

(22) Filed: Sep. 30, 2013

(30) Foreign Application Priority Data
Oct. 22, 2012 (JP) 2012-233075

(51) Int. Cl. G05F 1/66

(52) U.S. Cl. CPC G05F 1/66
USPC 700/295

(57) ABSTRACT

An environment control system comprising: a positioning system; and an electric facility control system, the positioning system comprising: at least one sensor configured to detect the location and the motion of the human being; and an operation unit configured to compute at least a value of a motion activity of the human being, the electric facility control system comprising: a determining unit configured to determine whether the human being is in a moving state or a resting state by comparing the value of the motion activity with a predetermined threshold value; and a controller configured to control the electric facility to change the environment of the given space, wherein the operation unit computes the value of the motion activity based on the operation result.

### CROSS-REFERENCE TO RELATED APPLICATIONS

The present application claims priority to and incorporates by reference the entire contents of Japanese Patent Application No. 2012-233075 filed in Japan on Oct. 22, 2012.

### BACKGROUND OF THE INVENTION

1. Field of the Invention

The present invention relates to a method, an apparatus, and a computer program product for controlling devices.

2. Description of the Related Art

In recent years, a variety of systems that controls various types of electrical devices placed at home, an office, or the like to save electric power and increase comfort are proposed. For example, a known technique improves energy efficiency and provides comfort to a person by detecting a position of a person and controlling a direction of air blown by an air conditioner and/or light intensity of a lighting device according to the position of the person. An example of such a technique is disclosed in Japanese Patent No. 4640286. In this technique, infrared sensors or ultrasonic sensors are arranged on a wall, ceiling, and/or the like to detect the position of the person three-dimensionally.

However, the technique disclosed in Japanese Patent No. 4640286 is disadvantageous in that because it is difficult to control a device in a manner that the device quickly responds to a person making a large motion, delay in control can give discomfort to the person.

In light of the foregoing, there is a need to provide an apparatus, a method, and a computer program product for controlling devices that allow saving electric power and increasing comfort while reducing discomfort given to a person making a large motion.

It is an object of the present invention to at least partially solve the problems in the conventional technology.

### SUMMARY OF THE INVENTION

It is an object of the present invention to at least partially solve the problems in the conventional technology.

According to an aspect of the invention, an environment control system for automatically controlling a space environment with an electric facility according to a location and a motion of a human being in a given space is provided. The environment control system includes: a positioning system; and an electric facility control system communicated with the positioning system, the positioning system comprising: at least one sensor configured to detect the location and the motion of the human being; and an operation unit communicated with the at least one sensor and configured to compute, based on the detection result from the at least one sensor, at least a value representing an absolute location of the human being from a reference point, a value representing a motion activity indicating a degree of the motion, and a value representing posture of the human being, and configured to transmit the computed values to the electric facility control system, the electric facility control system comprising: a determining unit configured to receive a signal from the operation unit, to compare the value of the motion activity with a predetermined threshold value and to determine that the human being in the given space is in a moving state if the value of the motion activity of the human being is higher than the predetermined threshold value, and to determine that the human being in the given space is in a resting state if the value of the motion activity of the human being is equal to or lower than the predetermined threshold value; and a controller communicated with the determining unit and configured to control the electric facility to change, according to the result of the determination, the environment of the given space containing the absolute position, wherein the operation unit performs the operation based on the detection result from the at least one sensor associated with a body of the human being, and the operation unit computes the value of the motion activity based on the operation result.

According to another aspect of the invention, a method for performing an environment control system for automatically controlling a space environment with an electric facility according to a location and a motion of a human being in a given space is provided. The environment control system includes: a positioning system; and an electric facility control system communicated with the positioning system, the positioning system comprising: at least one sensor configured to detect the location and the motion of the human being; and an operation unit communicated with the at least one sensor and configured to compute, based on the detection result from the at least one sensor, at least a value representing an absolute location of the human being from a reference point, a value representing a motion activity indicating a degree of the motion, and a value representing posture of the human being, and configured to transmit the computed values to the electric facility control system, the electric facility control system comprising: a determining unit configured to receive a signal from the operation unit, to compare the value of the motion activity with a predetermined threshold value and to determine that the human being in the given space is in a moving state if the value of the motion activity of the human being is higher than the predetermined threshold value, and to determine that the human being in the given space is in a resting state if the value of the motion activity of the human being is equal to or lower than the predetermined threshold value; and a controller communicated with the determining unit and configured to control the electric facility to change, according to the result of the determination, the environment of the given space containing the absolute position, the method comprising: by the operation unit, performing the operation based on the detection result from the at least one sensor associated with the body of the human being, and computing the value of the motion activity based on the operation result; by the determining unit, comparing the value of the motion activity with the predetermined threshold value and determining that the human being in the given space is in a moving state if the value of the motion activity of the human being is higher than the predetermined threshold value, and determining that the human being in the given space is in a resting state if the value of the motion activity of the human being is equal to or lower than the predetermined threshold value; and by the controller, controlling the electric facility to change, according to the result of the determination, the environment of the given space containing the absolute position.

According to further aspect of the invention, a computer readable medium including a computer program product, the computer program product comprising instructions which, when caused by a computer, causes the computer to perform operations for performing an environment control system for automatically controlling a space environment with an electric facility according to a location and a motion of a human being in a given space is provided. The environment control system includes: a positioning system; and an electric facility control system communicated with the positioning system, the positioning system comprising: at least one sensor configured to detect the location and the motion of the human being; and an operation unit communicated with the at least one sensor and configured to compute, based on the detection result from the at least one sensor, at least a value representing an absolute location of the human being from a reference point, a value representing a motion activity indicating a degree of the motion, and a value representing posture of the human being, and configured to transmit the computed values to the electric facility control system, the electric facility control system comprising: a determining unit configured to receive a signal from the operation unit, to compare the value of the motion activity with a predetermined threshold value and to determine that the human being in the given space is in a moving state if the value of the motion activity of the human being is higher than the predetermined threshold value, and to determine that the human being in the given space is in a resting state if the value of the motion activity of the human being is equal to or lower than the predetermined threshold value; and a controller communicated with the determining unit and configured to control the electric facility to change, according to the result of the determination, the environment of the given space containing the absolute position, the operations comprising: by the operation unit, performing the operation based on the detection result from the at least one sensor associated with the body of the human being, and computing the value of the motion activity based on the operation result; by the determining unit, comparing the value of the motion activity with the predetermined threshold value and determining that the human being in the given space is in a moving state if the value of the motion activity of the human being is higher than the predetermined threshold value, and determining that the human being in the given space is in a resting state if the value of the motion activity of the human being is equal to or lower than the predetermined threshold value; and by the controller, controlling the electric facility to change, according to the result of the determination, the environment of the given space containing the absolute position.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a network configuration diagram of a device control system according to an embodiment;

FIG. 2 is a diagram defining in what style and in which orientation a smartphone and sensors are worn;

FIG. 3 is a diagram illustrating an example, in which a worker wears an information device capable of detecting a motion of the worker apart from the smartphone;

FIGS. 4A and 4B are diagrams illustrating directions detected by respective sensors;

FIG. 5 is a diagram illustrating an example of placement of monitoring cameras in a room;

FIG. 6 is a diagram illustrating an example of placement of LED lighting devices, electrical outlets, and air conditioners in the room;

FIG. 7 is a block diagram illustrating a functional configuration of a location server;

FIG. 8 is a waveform diagram of a vertical acceleration component produced when each of a sitting motion and a standing motion is performed;

FIG. 9 is a waveform diagram of a horizontal angular velocity component produced when each of a squatting motion and a standing motion is performed;

FIG. 10 is a waveform diagram of a vertical angular velocity component produced by a motion of changing an orientation in a resting state;

FIG. 11 is a waveform diagram of a horizontal angular velocity component of a head of a worker that turns his/her eyes up away from a display in a sitting state;

FIG. 12 is a waveform diagram of a horizontal angular velocity component of the head of the worker that turns his/her eyes down away from the display in the sitting state;

FIG. 13 is a block diagram illustrating a functional configuration of a control server;

FIG. 14 is a diagram illustrating an example of a control table;

FIG. 15 is a flowchart illustrating an example of a procedure for a process to be performed by the location server; and

FIG. 16 is a flowchart illustrating an example of a procedure for a process to be performed by the control server.

### DETAILED DESCRIPTION OF THE PREFERRED EMBODIMENTS

A preferred embodiment of the present invention is described in detail below with reference to the accompanying drawings. The embodiment is described below by way of an example, in which a device control apparatus is embodied as a part of functions of a device control system that controls devices arranged in an office room, which is a control target area, according to positions and the like of persons (hereinafter, “workers”) carrying out specific business activities in the room. Note that applicable system is not limited to such a device control system.

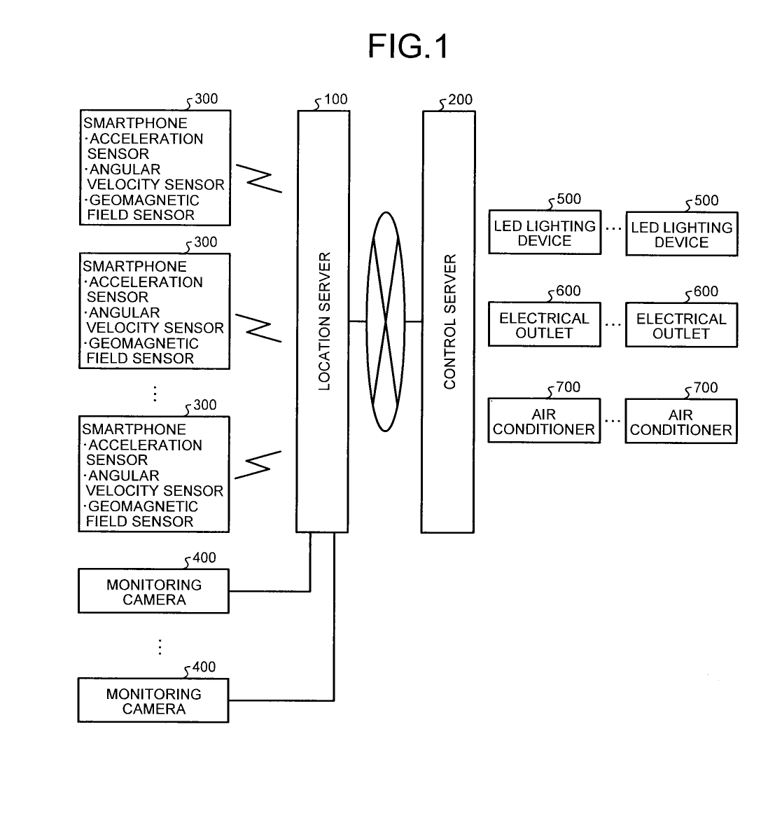

FIG. 1 is a network configuration diagram of the device control system according to the present embodiment. As illustrated in FIG. 1, the device control system of the present embodiment includes a plurality of smartphones 300, a plurality of monitoring cameras 400, a location server 100, a control server 200, and controlled devices. The controlled devices are a plurality of light-emitting diode (LED) lighting devices 500, a plurality of electrical outlets 600, and a plurality of air conditioners 700.

The plurality of smartphones 300 and the plurality of monitoring cameras 400 are connected to the location server 100 over a wireless communication network of, for example, Wireless Fidelity (Wi-Fi). Note that a method for wireless communications is not limited to Wi-Fi. The monitoring cameras 400 and the location server 100 may alternatively be wire-connected.

The location server 100 and the control server 200 are connected to a network, such as the Internet or a local area network (LAN).

The plurality of LED lighting devices 500, the plurality of electrical outlets 600, and the plurality of air conditioners 700 are connected to the control server 200 over a wireless communication network of, for example, Wi-Fi.

The method for communication between the control server 200, and the plurality of LED lighting devices 500, the plurality of electrical outlets 600, and the plurality of air conditioners 700 is not limited to Wi-Fi; another wireless communication method may be utilized. Further alternatively, a wired communication method using an Ethernet (registered trademark) cable, power line communications (PLC), or the like can be used.

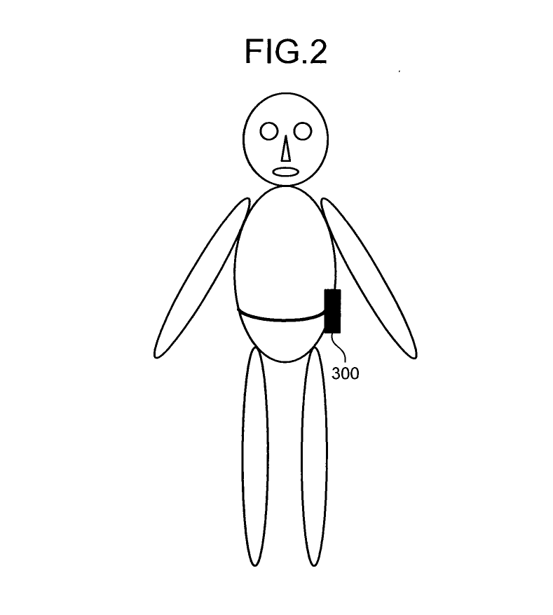

The smartphone 300 is an information device that is to be carried by a worker to detect a position and motion of the worker indoors. FIG. 2 is a diagram illustrating the smartphone 300 that is worn. The smartphone 300 may be carried by a hand or the like of the worker, or, alternatively, worn at waist of the worker as illustrated in FIG. 2.

Referring back to FIG. 1, each of the smartphones 300 includes an acceleration sensor, an angular velocity sensor, and a geomagnetic field sensor and transmits detection data output from each of the sensors to the location server 100 at fixed time intervals, e.g., every second. The detection data output from the acceleration sensor is an acceleration vector. The detection data output from the angular velocity sensor is an angular velocity vector. The detection data output from the geomagnetic field sensor is a magnetic vector. The location server 100 can detect the position and motion of the worker indoors based on the acceleration vector, the angular velocity vector, and the magnetic vector.

In the present embodiment, the smartphone 300 is used as the information device for detecting the position and motion of the worker indoors. However, the information device is not limited to the smartphone 300, and can be any information device that includes an acceleration sensor, an angular velocity sensor, and a geomagnetic field sensor.

The worker may wear, in addition to and apart from the smartphone 300, an information device that includes an acceleration sensor, an angular velocity sensor, and a geomagnetic field sensor.

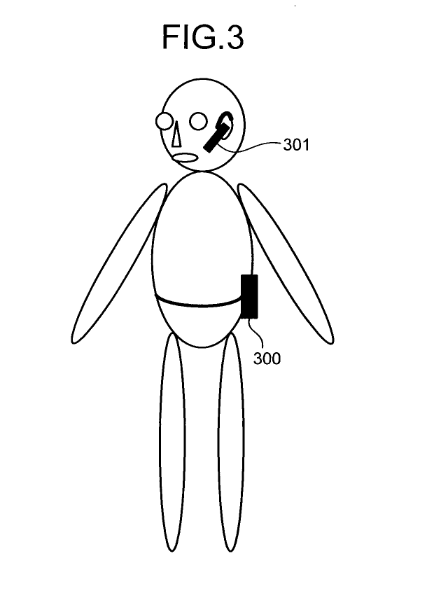

For instance, as illustrated in FIG. 3, the worker can wear a small headset-type sensor group 301 that includes an acceleration sensor, an angular velocity sensor, and a geomagnetic field sensor at the worker's head in addition to and apart from the smartphone 300. In this case, detection data obtained by the sensor group 301 can be either directly transmitted from the sensor group 301 to the location server 100 or transmitted to the location server 100 via the smartphone 300. It becomes possible to detect a variety of postures when the sensor group 301 is worn at the worker's head in this way apart from the sensors of the smartphone 300.

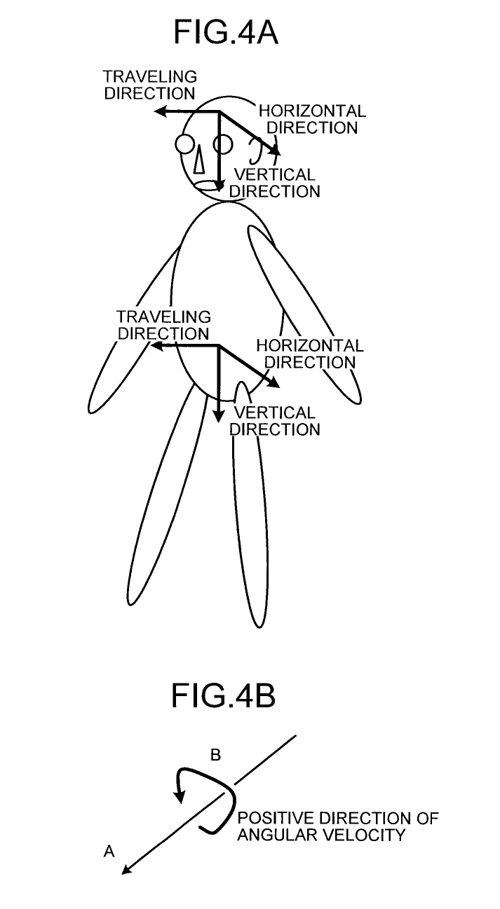

FIGS. 4A and 4B are diagrams illustrating directions detected by the sensors. FIG. 4A illustrates directions detected by the acceleration sensors and the geomagnetic field sensors. As illustrated in FIG. 4A, acceleration components in a traveling direction, the vertical direction, and the horizontal direction and geomagnetic field components are detectable using the acceleration sensors and the geomagnetic field sensors. FIG. 4B illustrates an angular velocity vector A detected by the angular velocity sensors. The positive direction of the angular velocity is indicated by an arrow B. In the embodiment, a projection of the angular velocity vector A in the traveling direction, a projection of the same in the vertical direction, and a projection of the same in the horizontal direction illustrated in FIG. 4A are referred to as an angular velocity component in the traveling direction, a vertical angular velocity component, and a horizontal angular velocity component, respectively.

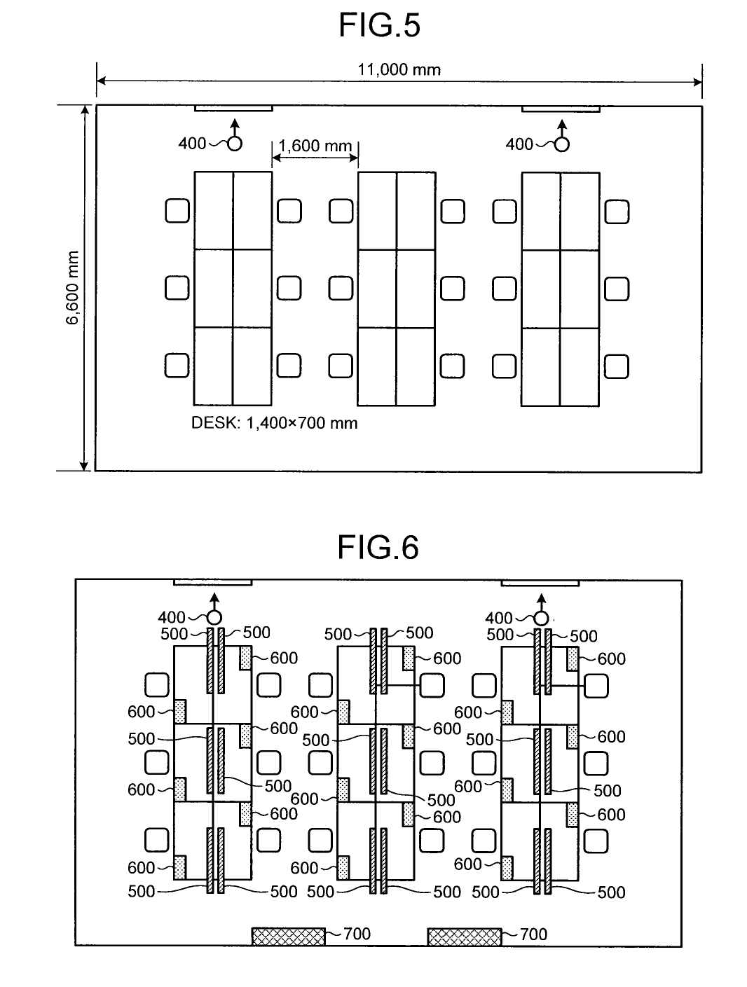

Referring back to FIG. 1, the monitoring cameras 400 that capture images of interior of the room, which is the control target area, are arranged near a top portion or the like of the room, which is the control target area. FIG. 5 is a diagram illustrating an example of placement of the monitoring cameras 400. In the example illustrated in FIG. 5, the monitoring cameras 400 are arranged, but not limited thereto, at two points near doors of the room. The monitoring camera 400 captures images of the interior of the room which is the control target area, and transmits the captured images (captured video) to the location server 100.

Referring back to FIG. 1, power control is performed on a lighting system, an electrical outlet system, an air-conditioning system in the embodiment. More specifically, power control is performed on the plurality of LED lighting devices 500 corresponding to the lighting system, the plurality of electrical outlets 600 corresponding to the electrical outlet system, and the plurality of air conditioners 700 corresponding to the air-conditioning system.

The plurality of LED lighting devices 500, the plurality of electrical outlets 600, and the plurality of air conditioners 700 are installed in the room, which is the control target area. FIG. 6 is a diagram illustrating an example of placement of the LED lighting devices 500, the electrical outlets 600, and the air conditioners 700.

As illustrated in FIG. 6, the room contains three desk groups each consisting of six desks. Each desk is provided with one of the LED lighting devices 500 and one of the electrical outlets 600. By contrast, each of the air conditioners 700 is interposed between adjacent pair of the groups. Note that the placement of the LED lighting devices 500, the electrical outlets 600, and the air conditioners 700 illustrated in FIG. 6 is exemplary only, and not limiting.

Information about a sum total of power consumptions in the room of the present embodiment can be obtained from a utility-grid power meter (not shown in FIG. 6) arranged outside the room.

Eighteen workers are carrying out specific business activities in the room. Each worker enters and leaves the room by any one of two doors. In the present embodiment, the layout, the devices, the number of users, and the like are limited; however, the embodiment is applicable to a wider variety of layouts and devices. Moreover, the embodiment is also applicable, by being highly-flexibly adapted, to a wide range of space size and the number of users, a wide range of variations of attributes of individual users or groups of users, and a wide range of business activities carried out by individual users or groups of users. Application of the present embodiment is not limited to an indoor space such as is illustrated in FIGS. 5 and 6; the present embodiment may be applied to an outdoor space or the like.

The location server 100 and the control server 200 of the present embodiment are arranged outside the room illustrated in FIGS. 5 and 6. The power control is not performed on the location server 100 and the control server 200 in the present embodiment. However, alternatively, the power control may be performed on these.

The power control is not performed on network devices, such as a Wi-Fi access point, a switching hub, and a router that make up a communication network system, in the embodiment. However, the power control may alternatively be performed on these devices.

Power consumption of these network devices can be calculated by subtracting total power consumption of the LED lighting devices 500, the air conditioners 700, and the electrical outlets 600 from the total power consumption measured by the system electric power meter.

The control server 200 controls each of the plurality of LED lighting devices 500, the plurality of electrical outlets 600, and the plurality of air conditioners 700 by remote control over the network.

More specifically, the control server 200 controls power-on/off, dimming levels, and the like of the LED lighting devices 500 by remote control. The LED lighting devices 500 having dimming feature are used as a lighting system that illuminates the interior of the room, which is the control target area, with low power consumption factored into consideration. The control server 200 remotely and individually controls power-on/off, dimming levels, and the like of the LED lighting devices 500 wirelessly via Wi-Fi.

Other lighting devices each including a light-emitting unit other than an LED may be used as the lighting system.

The control server 200 remotely controls power-on/off and air-conditioning intensities of the air conditioners 700. More specifically, the air conditioners 700 are configured to be individually remote controllable. Factors to be controlled of the air conditioner 700 include air-conditioning intensity in addition to power-on/off. However, the factors to be controlled are not limited thereto. Temperature and humidity, which are not included in the factors to be controlled in the present embodiment, may be included in the factors.

Each of the electrical outlets 600 includes a plurality of sockets. The control server 200 switches on and off power supply to each of the sockets by remote control. More specifically, each of the electrical outlets 600 includes on/off switches that are remote controllable on a socket-by-socket basis. The control server 200 wirelessly controls the on/off switching via Wi-Fi. The number of the sockets contained in each one of the electrical outlets 600 can be an arbitrary number. For example, an electrical outlet made up of four sockets can be used.

As illustrated in FIG. 6, each desk is provided with one of the electrical outlets 600. Electrical devices (not shown) can be plugged into the electrical outlet 600. Specific examples of the electrical devices include a personal computer (PC) system unit and a display device.

In the present embodiment, a PC system unit for use by a worker in performing a business activity is plugged into one of the sockets of the electrical outlet 600. The control server 200 controls on/off of electric power to be supplied to the socket, thereby performing power-on/off control of the PC system unit. The PC system unit has a function of state transition between a standby state where power consumption is low and an active state where power consumption is high. The PC system unit is configured in such a manner that the control server 200 can wirelessly control this state transition between the standby state and the active state via Wi-Fi.

In the present embodiment, a display device, for which facing relationship with a person matters much, is plugged into one of the sockets of the electrical outlet 600. The display device is a device of which power-on/off is controllable by the control server 200 by controlling on/off of electric power to be supplied to the socket. The display device is configured in such a manner that a control program stored in any one of the display device itself and the PC system unit connected to the display device can adjust a brightness level of a display screen. The control server 200 can wirelessly control the brightness level of the display screen via Wi-Fi.

Referring back to FIG. 1, the location server 100 receives detection data output from the sensors of each of the smartphones 300 carried by the workers. The location server 100 calculates a motion activity level of each of the workers carrying the smartphone 300 and detects an absolute position, a direction, a posture, and the like of the worker based on the detection data. The motion activity level indicates a magnitude of motion of the worker. The location server 100 transmits the detected motion activity level, absolute position, direction, posture, and the like of the worker as detection result data to the control server 200.

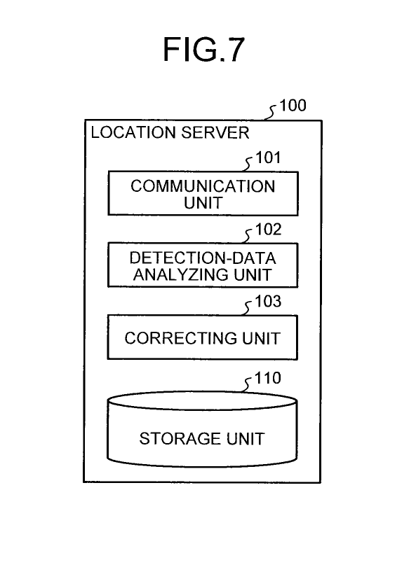

FIG. 7 is a block diagram illustrating a functional configuration of the location server 100. As illustrated in FIG. 7, the location server 100 includes a communication unit 101, a detection-data analyzing unit 102, a correcting unit 103, and a storage unit 110.

The storage unit 110 is a storage medium such as a hard disk drive (HDD) or a memory and stores various information necessary for processing performed by the location server 100. The information includes map data of inside of the room, which is the control target area.

The communication unit 101 receives detection data from each of the acceleration sensor, the angular velocity sensor, and the geomagnetic field sensor mounted on the smartphone 300 or the acceleration sensor, the angular velocity sensor, and the geomagnetic field sensor of the sensor group 301, which is independent from the smartphone 300. More specifically, the communication unit 101 receives an acceleration vector from the acceleration sensor, an angular velocity vector from the angular velocity sensor, and a magnetic vector from the geomagnetic field sensor.

The communication unit 101 also receives captured images from the monitoring cameras 400. Moreover, the communication unit 101 transmits the detection result data, which will be described later, including the motion activity level, the absolute position, the direction, and the posture of the worker to the control server 200.

The detection-data analyzing unit 102 analyzes the detection data received by the communication unit 101 and calculates the motion activity level of the worker in the room. The detection-data analyzing unit 102 also detects an absolute position of the worker in the room with an accuracy of human shoulder breadth or step length and, furthermore, detects a direction, a posture, and the like of the worker in the room.

More specifically, when it is detected that a worker has entered the room by one of the doors based on the captured images fed from the monitoring cameras 400, the detection-data analyzing unit 102 continually determines a motion of the worker. This determination is made by using time series detection data continually received from the acceleration sensor, the angular velocity sensor, and the geomagnetic field sensor of the smartphone 300 worn by the worker entering the room or the acceleration sensor, the angular velocity sensor, and the geomagnetic field sensor of the sensor group 301 which is apart from the smartphone 300. For brevity of description, it is assumed below that the motion of the worker is limited to a walking motion, which is a horizontal movement of the body of the worker. Meanwhile, the motion of the worker may be determined inclusive of a sitting motion and a standing motion, which is a vertical movement of the body of the worker, and/or inclusive of changes in orientation (direction) of the body of the worker. The sitting motion and the standing motion can be determined based on a gravitational acceleration vector obtained from an acceleration vector and an angular velocity vector of the detection data as will be described later. The orientation of the body of the worker can be determined based on a direction of a magnetic vector of the detection data.

The detection-data analyzing unit 102 determines whether or not the worker is in the walking state using the acceleration vector and the angular velocity vector of the detection data first. For instance, the detection-data analyzing unit 102 can determine whether or not the worker is in the walking state using the acceleration vector and the angular velocity vector of the detection data in the following manner as done by a dead reckoning device disclosed in Japanese Patent No. 4243684.

More specifically, the detection-data analyzing unit 102 obtains the gravitational acceleration vector from the acceleration vector received from the acceleration sensor and the angular velocity vector received from the angular velocity sensor, and then subtracts the gravitational acceleration vector from the acceleration vector to remove the acceleration in the vertical direction. The detection-data analyzing unit 102 thus obtains time-series remainder-acceleration-component data. The detection-data analyzing unit 102 performs principal component analysis of the time-series remainder-acceleration-component data, thereby determining a traveling direction of a walking motion. The detection-data analyzing unit 102 then searches the vertical acceleration component for a pair of a peak and a valley, and searches the acceleration component in the traveling direction for a pair of a valley and a peak. The detection-data analyzing unit 102 calculates a gradient of the acceleration component in the traveling direction.

The detection-data analyzing unit 102 then determines whether or not the gradient of the acceleration component in the traveling direction is equal to or greater than a predetermined value at time when the valley of a declining portion from the peak to the valley of the vertical acceleration component is detected. When the gradient is equal to or greater than the predetermined value, the detection-data analyzing unit 102 determines that the worker is in the walking state. When the worker is determined as being in the walking state, the detection-data analyzing unit 102 calculates an acceleration vector generated by the walking motion from the gravitational acceleration vector and the acceleration vector, for instance. The detection-data analyzing unit 102 calculates a magnitude of the walking motion from the gravitational acceleration vector and the acceleration vector generated by the walking motion, and calculates the motion activity level based on the magnitude. When the detection-data analyzing unit 102 has determined that the worker is not in the walking state, the detection-data analyzing unit 102 may set the motion activity level to zero, for instance. Alternatively, when the detection-data analyzing unit 102 has determined that the worker is not in the walking state, the detection-data analyzing unit 102 may calculate the motion activity level from a vertical distance the body of the worker has moved and an amount of change in orientation of the body of the worker. The methods for calculating the motion activity level described above are merely examples and are not limiting. The motion activity level can be calculated by using any one or a combination of a plurality of methods for calculating a magnitude of a motion of a person.

The detection-data analyzing unit 102 then obtains a relative displacement vector of the worker with respect to a reference position, which is the position of the door, using the acceleration vector, the angular velocity vector, and the magnetic vector. Meanwhile, as a method for calculating the relative displacement vector using the acceleration vector, the angular velocity vector, and the magnetic vector, a method disclosed in Japanese Patent Application Laid-open No. 2011-47950 relating to a process performed by a dead reckoning device can be employed, for example.

More specifically, the detection-data analyzing unit 102 can obtain the relative displacement vector in the following manner as done by the dead reckoning device disclosed in Japanese Laid-open Patent Application No. 2011-47950.

That is, the detection-data analyzing unit 102 obtains a gravity direction vector from the acceleration vector received from the acceleration sensor and the angular velocity vector received from the angular velocity sensor. The detection-data analyzing unit 102 calculates a posture angle of the person as a traveling direction based on the gravity direction vector, and the angular velocity vector or the magnetic vector received from the geomagnetic field sensor. The detection-data analyzing unit 102 obtains a gravitational acceleration vector from the acceleration vector and the angular velocity vector. The detection-data analyzing unit 102 calculates an acceleration vector generated by the walking motion from the gravitational acceleration vector and the acceleration vector. The detection-data analyzing unit 102 detects a walking motion by analyzing the gravitational acceleration vector and the acceleration vector generated by the walking motion. The detection-data analyzing unit 102 measures a magnitude of the walking motion from the gravitational acceleration vector and the acceleration vector generated by the walking motion, and assumes a result of this measurement as a step length. The detection-data analyzing unit 102 obtains a relative displacement vector with respect to the reference position by integrating the traveling direction and the step length obtained as described above. In this manner, the detection-data analyzing unit 102 detects a position of the worker in real time with the accuracy of human step length or shoulder breadth, which is approximately 60 centimeters or smaller (more specifically, approximately 40 centimeters or smaller), for example.

When the relative displacement vector has been calculated as described above, the detection-data analyzing unit 102 determines an absolute position of the worker based on the relative displacement vector with respect to the door and the map data of the inside of the room stored in the storage unit 110. The detection-data analyzing unit 102 can thus determine the position of the worker in the room with the accuracy of, for example, human shoulder breadth, which is approximately 60 centimeters or smaller (more specifically, approximately 40 centimeters or smaller).

It does not always hold true that the higher the position accuracy, the better. For instance, in a situation where two or more people are having conversation, they are rarely in contact with each other but generally a certain distance away from each other. In the embodiment, with regard to the accuracy, accuracy of approximately the human shoulder breadth or step length is considered as appropriate; accuracy of approximately the length from the waist to the knees is considered as appropriate in determination as to whether which one of the standing state or the sitting state is taken.

The anthropometric data (Makiko Kouchi, Masaaki Mochimaru, Hiromu Iwasawa, and Seiji Mitani, (2000): Anthropometric database for Japanese Population 1997-98, Japanese Industrial Standards Center (AIST, MITI)) released by the Ministry of Health, Labor and Welfare, contains data about bisacromial breadths, which correspond to shoulder breadths, of young adult and elderly men and women. According to this data, an average shoulder breadth of elderly women, which is the smallest among averages, is approximately 35 centimeters (34.8 centimeters), while an average shoulder breadth of young adult men, which is the greatest among the averages, is approximately 40 centimeters (39.7 centimeters). According to the anthropometric data, differences between lengths from waists to knees ((suprasternal heights)−(lateral epicondyle heights)) are approximately 34 to 38 centimeters. Meanwhile, because people take approximately 95 steps to walk 50 meters, step length of moving people can be calculated as approximately 53 (=50/95×10) centimeters. The method for position detection according to the embodiment can achieve the accuracy of approximately the step length. Therefore, based on this data, the embodiment is configured on an assumption that the accuracy of 60 centimeters or smaller, more preferably 40 centimeters or smaller, is appropriate. The data referred to here can be used as reference data in determination of the accuracy; however, this data is based on measurements performed on Japanese people, and accuracy to be employed is not limited to these numerical values.

When the detected absolute position of the worker is in front of a desk arranged in the room, the detection-data analyzing unit 102 determines a direction (orientation) of the worker relative to a display device based on the direction of the magnetic vector received from the geomagnetic field sensor. Furthermore, when the detected absolute position of the worker is in front of a desk arranged in the room, the detection-data analyzing unit 102 determines a posture of the worker, or, more specifically, whether the worker is in the standing state or in the sitting state, based on the vertical acceleration component of the acceleration vector.

The determination as to whether the worker is in the standing state or in the sitting state can be made in the following manner as done by the dead reckoning device disclosed in Japanese Patent No. 4243684. That is, a gravitational acceleration vector is calculated from the acceleration vector received from the acceleration sensor and the angular velocity vector received from the angular velocity sensor to obtain the vertical acceleration component. The detection-data analyzing unit 102 detects a peak and a valley of the vertical acceleration component as done by the dead reckoning device disclosed in Japanese Patent No. 4243684, for example.

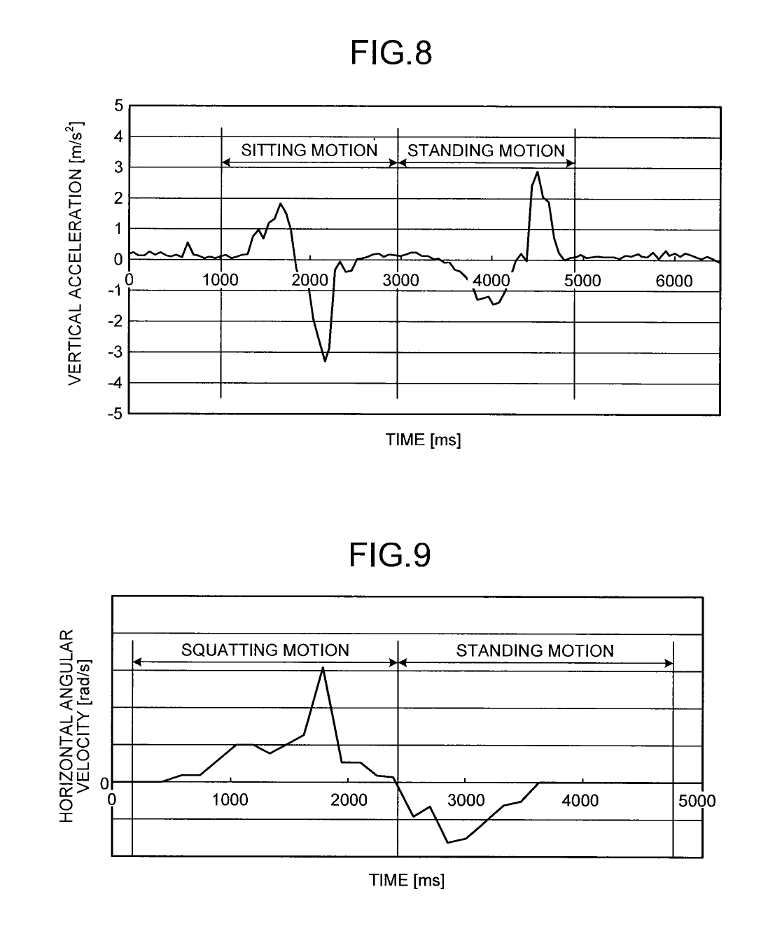

FIG. 8 is a waveform diagram of a vertical acceleration component produced when each of a sitting motion and a standing motion is performed. As illustrated in FIG. 8, a peak-to-valley period of the vertical acceleration component produced by the sitting motion is approximately 0.5 seconds. A valley-to-peak period of the vertical acceleration component produced by the standing motion is approximately 0.5 seconds. Accordingly, the detection-data analyzing unit 102 determines whether the worker is in the sitting state or in the standing state based on these peak-to-valley/valley-to-peak periods. More specifically, the detection-data analyzing unit 102 determines that a motion state of the worker is the sitting state when the peak-to-valley period of the vertical acceleration component is equal to or within a predetermined range from 0.5 seconds. The detection-data analyzing unit 102 determines that the motion state of the worker is the standing state when the valley-to-peak period of the vertical acceleration component is equal to or within a predetermined range from 0.5 seconds.

The detection-data analyzing unit 102 determines whether the motion state of the worker is the standing state or in the sitting state in this manner, thereby detecting a vertical position of the worker with an accuracy of approximately 50 centimeters or smaller (more specifically, approximately 40 centimeters or smaller).

As in the example illustrated in FIG. 3, a worker can wear the smartphone 300 including the information device for detecting a motion of the worker such as the acceleration sensor, the angular velocity sensor, and the geomagnetic field sensor at the waist, and, in addition thereto, the small headset-type sensor group 301 that includes the acceleration sensor, the angular velocity sensor, and the geomagnetic field sensor at the head. In this case, the detection-data analyzing unit 102 can further detect the following postures and motions of the worker.

FIG. 9 is a waveform diagram of a horizontal angular velocity component produced when each of a squatting motion and a standing motion is performed. A waveform similar to that of the waveform of the sitting motion and the standing motion illustrated in FIG. 8 is observed in a plot of acceleration data output from the acceleration sensor. However, it is difficult to discriminate between the squatting motion and the standing motion based on only the acceleration data.

For this reason, the detection-data analyzing unit 102 discriminates between the squatting motion and the standing motion by, in addition to using the method described above for discriminating between the sitting motion and the standing motion based on the waveform illustrated in FIG. 8, determining whether or not horizontal angular velocity data received from the angular velocity sensor plotted against time fits the waveform illustrated in FIG. 9.

More specifically, first, the detection-data analyzing unit 102 determines whether or not the peak-to-valley period of the vertical acceleration component obtained from the acceleration vector received from the acceleration sensor is equal to or within a predetermined range from 0.5 seconds.

When the peak-to-valley period of the vertical acceleration component is equal to or within the predetermined range from 0.5 seconds, the detection-data analyzing unit 102 determines that the motion of the worker is the squatting motion in the following case. That is, a horizontal angular velocity component of the angular velocity vector received from the angular velocity sensor changes to fit the waveform illustrated in FIG. 9 in such manner that the horizontal angular velocity component gradually increases from zero, thereafter sharply increases to reach the peak, then sharply decreases from the peak, and thereafter gradually decreases to become zero again, taking time of approximately 2 seconds.

The detection-data analyzing unit 102 determines whether or not the valley-to-peak period of the vertical acceleration component is equal to or within the predetermined range from 0.5 seconds. When the valley-to-peak period of the vertical acceleration component is equal to or within the predetermined range from 0.5 seconds, the detection-data analyzing unit 102 determines that the motion of the worker is the standing motion in the following case. That is, a horizontal angular velocity component of the angular velocity vector received from the angular velocity sensor changes to fit the waveform illustrated in FIG. 9 in such manner that the horizontal angular velocity component decreases in stages from zero to reach the valley and gradually increases from the valley to become zero again, taking time of approximately 1.5 seconds.

The angular velocity vector received from the angular velocity sensor worn at the head is preferably employed as the angular velocity vector for use by the detection-data analyzing unit 102 in making this determination between the squatting motion and the standing motion. This is because the horizontal angular velocity component obtained from the angular velocity vector output from the angular velocity sensor worn at the head distinctively exhibits the waveform illustrated in FIG. 9 related to the squatting motion and the standing motion.

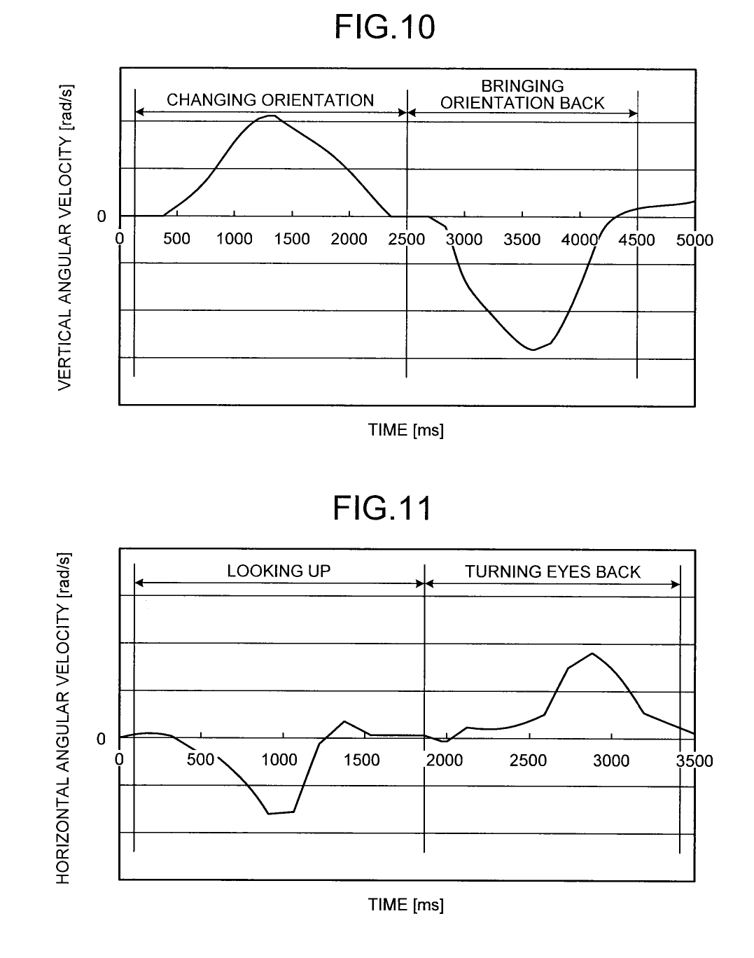

FIG. 10 is a waveform diagram of a vertical angular velocity component produced by a motion of changing the worker's orientation approximately 90 degrees in the resting state. When the vertical angular velocity component is positive, an orientation-changing motion to the right is performed, while when the vertical angular velocity component is negative, an orientation-changing motion to the left is performed.

The detection-data analyzing unit 102 determines that the orientation-changing motion to the right is performed when the vertical angular velocity component of the angular velocity vector received from the angular velocity sensor changes with time to fit the waveform illustrated in FIG. 10 in such a manner that the vertical angular velocity component gradually increases from zero to reach a peak and then gradually decreases to become zero again, taking time of approximately 3 seconds.

The detection-data analyzing unit 102 determines that the orientation-changing motion to the left is performed when the vertical angular velocity component changes with time to fit the waveform illustrated in FIG. 10 in such a manner that the vertical angular velocity component gradually decreases from zero to reach a valley and then gradually increases to become zero again, taking time of approximately 1.5 seconds.

The detection-data analyzing unit 102 determines that a motion of changing an orientation of an entire body to the right or the left is performed when both of the vertical angular velocity component of the angular velocity vector received from the angular velocity sensor at the head and that received from the angular velocity sensor of the smartphone 300 at the waist change with time similarly to the waveform illustrated in FIG. 10 in the determination described above.

On the other hand, the detection-data analyzing unit 102 determines that a motion of changing an orientation of only the head to the right or the left is performed in the following case. That is, whereas the vertical angular velocity component of the angular velocity vector received from the angular velocity sensor at the head changes with time similarly to the waveform illustrated in FIG. 10, the vertical angular velocity component of the angular velocity vector received from the angular velocity sensor of the smartphone 300 at the waist changes with time completely differently from the waveform illustrated in FIG. 10. Such a motion can conceivably be made when, for example, the worker changes the worker's posture to have conversation with an adjacent worker while staying seated.

FIG. 11 is a waveform diagram of a horizontal angular velocity component of an angular velocity vector received from the angular velocity sensor at the head of a worker that turns the worker's eyes up away from a display in a sitting state.

Assumed below is a situation where the detected absolute position of the worker is in front of a desk arranged in the room and the detected posture of the worker in front of the desk is the sitting state. In such a situation, the detection-data analyzing unit 102 determines that a motion (looking-up motion) of turning the worker's eyes up away from the display in the sitting state is performed in the following case. That is, the horizontal angular velocity component of the angular velocity vector received from the angular velocity sensor at the head of the worker changes to fit the waveform illustrated in FIG. 11 in such a manner that the horizontal angular velocity component gradually decreases from zero to reach a valley and then sharply increases to become zero again, taking time of approximately 1 second. The detection-data analyzing unit 102 further determines that a motion of turning the worker's eyes back to the display from the state where the worker has turned the eyes up away from the display in the sitting state is performed in the following case. That is, the horizontal angular velocity component changes to fit the waveform illustrated in FIG. 11 in such a manner that the horizontal angular velocity component gradually increases from zero to reach a peak and thereafter gradually decreases to become zero again, taking time of approximately 1.5 seconds.

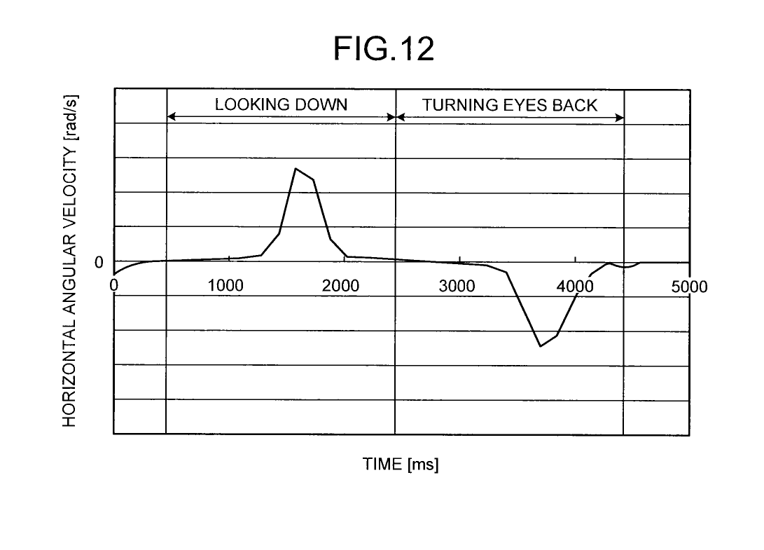

FIG. 12 is a waveform diagram of a horizontal angular velocity component of an angular velocity vector received from the angular velocity sensor at the head of a worker that turns the worker's eyes down away from a display in a sitting state.

Assumed below is a situation where the detected absolute position of the worker is in front of a desk arranged in the room and the detected posture of the worker in front of the desk is the sitting state. In such a situation, the detection-data analyzing unit 102 determines that a motion (looking-down motion) of turning the worker's eyes down away from the display in the sitting state is performed in the following case. That is, the horizontal angular velocity component of the angular velocity vector received from the angular velocity sensor at the head of the worker changes to fit the waveform illustrated in FIG. 12 in such a manner that the horizontal angular velocity component sharply increases from zero to reach a peak and then sharply decreases to become zero again, taking time of approximately 0.5 seconds.

The detection-data analyzing unit 102 further determines that a motion of turning the worker's eyes back to the display from the state where the worker has turned the eyes down away from the display in the sitting state is performed in the following case. That is, the horizontal angular velocity component changes to fit the waveform illustrated in FIG. 12 in such a manner that the horizontal angular velocity component sharply decreases from zero to reach a valley and thereafter sharply increases to become zero again, taking time of approximately 1 second.

The detection-data analyzing unit 102 can make determination about the postures and the motions that can be daily taken by office workers using the methods described above. The postures and motions include walking (standing state), standing up (resting state), sitting in a chair, squatting during a work, changing an orientation (direction) in the sitting state or in the standing state, casting eyes to the ceiling in the sitting state or in the standing state, and looking down in the sitting state or in the standing state. The detection-data analyzing unit 102 may calculate the motion activity level by taking not only a magnitude of the walking motion but also a magnitude of the motion determined as described above into consideration.

When the technique related to the dead reckoning device disclosed in Japanese Patent No. 4243684 is used, an ascending/descending motion of people in an elevator is also judged using the vertical acceleration component as disclosed in Japanese Patent No. 4243684.

Accordingly, in the present embodiment, the detection-data analyzing unit 102 can determine highly accurately that the standing motion or the sitting motion, rather than an ascending/descending motion in an elevator detected by the dead reckoning device disclosed in Japanese Patent No. 4243684, is performed when a vertical acceleration component that fits the waveform illustrated in FIG. 8 is detected at a location where no elevator is provided by using a function of a map matching device disclosed in Japanese Laid-open Patent Application No. 2009-14713, for example.

The correcting unit 103 corrects the absolute position, direction, posture, and the like of the worker in the room based on the captured images fed from the monitoring cameras 400 and the map data stored in the storage unit 110. More specifically, the correcting unit 103 determines whether or not the absolute position, direction, posture, and the like of the worker determined as described above are correct by performing image analysis or the like of the captured images fed from the monitoring cameras 400 and using the map data of the inside of the room, which is the control target area, and the function of the map matching device disclosed in Japanese Laid-open Patent Application No. 2009-14713, for example. When they are determined to be incorrect, the correcting unit 103 corrects them to a correct absolute position, direction, posture, and the like that are obtained from the captured images and/or the function of the map matching device.

The correcting unit 103 does not necessarily perform the correction using the captured images fed from the monitoring cameras 400. Alternatively, the correcting unit 103 may be configured to perform the correction using restrictive means such as short-range wireless communication, e.g., a radio frequency identification (RFID) or Bluetooth (registered trademark), or optical communication.

In the present embodiment, calculation of the motion activity level of the worker in the room and detection of the absolute position, direction, posture, and the like of the worker are performed using the technique similar to the technique related to the dead reckoning device disclosed in Japanese Patent No. 4243684, that disclosed in Japanese Laid-open Patent Application No. 2011-47950, and the technique similar to the technique related to the map matching device disclosed in Japanese Laid-open Patent Application No. 2009-14713. However, an employable detection method is not limited thereto.

There are known other methods that allow detecting a position of people than the described method performed by the location server 100 based on detection data from the acceleration sensor, the angular velocity sensor, and the geomagnetic field sensor. The other methods include: room entry/exit management using IC cards or the like; detecting people using a motion sensor; a method using a wireless LAN; a method using indoor GPS (Indoor Messaging System (IMES)); a method of performing image processing on images captured by a camera; a method using an active RFID; and a method using visible light communication.

The room entry/exit management using an IC card or the like allows identifying individuals; however, accuracy in position determination is the overall area to be managed, which is considerably low. Accordingly, although information about who are in the area can be acquired, information about activity states of people in the area cannot be acquired.

Detecting people using a motion sensor yields accuracy in position determination of approximately 1 to 2 meters, which is a detection area of the motion sensor; however, individuals cannot be identified. Furthermore, it is necessary to place and distribute a large number of motion sensors across an area to obtain information about activity states of people in the area.

The method using a wireless LAN is performed by measuring distances between a single wireless LAN terminal carried by people and a plurality of LAN access points placed in an area and determining a position of the person in the area using the principle of triangulation. This method allows identifying individuals; however, because accuracy in position determination largely depends on environment, accuracy in position determination is generally 3 meters or greater, which is relatively low.

The method using indoor GPS is performed by placing a transmitter, which is dedicated to this purpose, that emits radio waves of the same frequency band as that of GPS satellites inside a building and causing the transmitter to transmit a signal, in which position information is embedded at a portion originally for use by a GPS satellite to transmit time information. The signal is received by a receiver terminal carried by people inside the building. As a result, the position of the person inside the building is determined. This method allows identifying individuals; however, accuracy in position determination is approximately 3 to 5 meters, which is relatively low. Moreover, the necessity of installing the transmitter, which is dedicated to this purpose, increases cost for introducing this method.

The method of performing image processing on images captured by a camera yields accuracy in position determination of several tens of centimeters, which is relatively high; however, it is difficult to identify individuals with this method. For this reason, in the location server 100 of the present embodiment, captured images fed from the monitoring cameras 400 are used only in correcting the absolute position, direction, posture, and the like of the worker.

The method using an active RFID is performed by determining a position of people by causing the person to carry an RFID tag with an internal battery and reading information from the RFID tag using a tag reader. This method allows identifying individuals; however, because accuracy in position determination largely depends on environment, accuracy in position determination is generally 3 meters or greater, which is relatively low.

The method using visible light communication allows identifying individuals and, furthermore, yields accuracy in position determination of several tens of centimeters, which is relatively high. However, people cannot be detected at a place where visible light is shielded; moreover, it is difficult to maintain stability in detection accuracy because there are a plenty of sources of noise and interference, such as natural light and other visible light.

In contrast to these techniques, the method performed by the location server 100 of the present embodiment allows not only identifying individuals but also yields high accuracy in position determination of approximately the human shoulder breadth or step length. Furthermore, the method allows detecting not only positions of the individuals but also motions of the individuals. More specifically, the following postures and motions that can be daily taken by office workers can be detected as human motions using the method performed by the location server 100 of the present embodiment. The motions include walking (standing state), standing up (resting state), sitting in a chair, squatting during a work, changing an orientation (direction) in the sitting state or in the standing state, casting eyes to the ceiling in the sitting state or in the standing state, and looking down in the sitting state or in the standing state.

Accordingly, in the present embodiment, the location server 100 calculates the motion activity level of each worker in the room, which is the control target area, and detects the absolute position, the direction, the posture, and the like of the worker in the room based on the detection data output from the acceleration sensors, the angular velocity sensors, and the geomagnetic field sensors of the smartphone 300 and the sensor group 301 using the method described above. However, a method for calculating the motion activity level of each worker in the room, which is the control target area, and detecting the absolute position, the direction, the posture, and the like of the worker in the room is not limited to the method performed by the location server 100 described above. For example, the absolute position and a motion state of each worker may alternatively be detected by using one of or a combination of a plurality of methods other than the method described above. Further alternatively, calculation of the motion activity level of each worker in the room and detection of the absolute position, the direction, the posture, and the like of the worker in the room may be performed by using a combination of the method described above performed by the location server 100 and one or more of the other methods described above. For instance, although it is difficult to identify individuals using the method of performing image processing on images captured by a camera, this method allows detecting not only positions of the individuals but also motions of the individuals. Accordingly, calculation of the motion activity level of each worker in the room and detection of the absolute position, the direction, the posture, and the like of the worker in the room may be performed by using only the method of performing image processing on images captured by a camera or by using a combination of this method and the method performed by the location server 100 described above.

The control server 200 is described in detail below. The control server 200 remotely controls each of the plurality of LED lighting devices 500, the plurality of electrical outlets 600, and the plurality of air conditioners 700 arranged in the room over the network based on the motion activity levels, the absolute positions, the directions, the postures, and the like of the workers in the room.

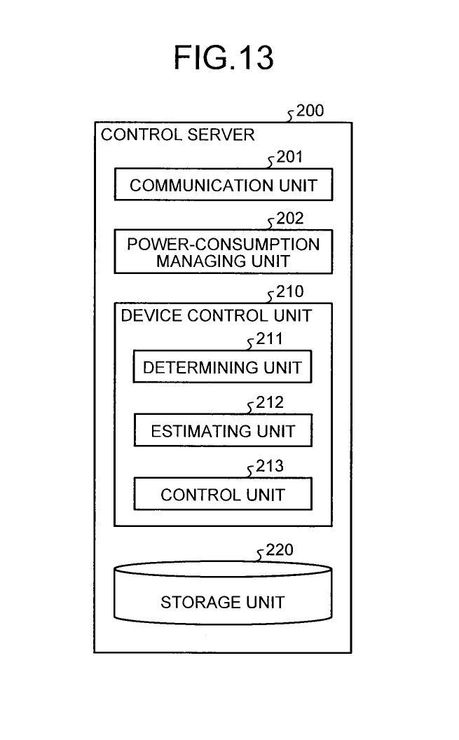

FIG. 13 is a block diagram illustrating a functional configuration of the control server 200 according to the present embodiment. As illustrated in FIG. 13, the control server 200 according to the present embodiment includes a communication unit 201, a power-consumption managing unit 202, a device control unit 210, and a storage unit 220.

The storage unit 220 is a storage medium, such as an HDD or a memory, and stores various types of information necessary for processing by the control server 200. The information includes position data about the desks and the like arranged in the room, which is the control target area, position data about each of the devices (the plurality of LED lighting devices 500, the plurality of electrical outlets 600, and the plurality of air conditioners 700) arranged in the room, and a control table for use in device control, which will be described later.

The communication unit 201 receives detection result data including the motion activity levels, the absolute positions, the directions, and the postures of the workers from the location server 100. The communication unit 201 also receives power consumptions from the plurality of LED lighting devices 500, electrical devices plugged into the plurality of electrical outlets 600, and the plurality of air conditioners 700. The communication unit 201 transmits control signals to each of the plurality of LED lighting devices 500, the plurality of electrical outlets 600 (and the PC system units, the display devices, and the like plugged into the electrical outlets 600), and the plurality of air conditioners 700, thereby individually controlling them.

The power-consumption managing unit 202 manages the power consumptions received from the plurality of LED lighting devices 500, the electrical devices plugged into the plurality of electrical outlets 600, and the plurality of air conditioners 700. The power-consumption managing unit 202 can acquire and manage information about total power consumption of the entire office, which is the control target area, by obtaining not only the power consumptions on a per-controlled-device basis but also a total of electric-system-by-electric-system power consumptions from the system electric power meter described above. The information about power consumptions managed by the power-consumption managing unit 202 can be used for a purpose of implementing what is called as “information presentation in visual form” by being displayed on a display, for example.

The device control unit 210 includes a determining unit 211, an estimating unit 212, and a control unit 213.

The determining unit 211 determines, for each of the workers in the room, which is the control target area, whether the worker is in the moving state or in the resting state by comparing the motion activity level contained in the detection result data received by the communication unit 201 against a preset threshold value. The determining unit 211 makes the determination as follows: if the motion activity level is higher than the threshold value, the worker is in the moving state; if the motion activity level is equal to or lower than the threshold value, the worker is in the resting state. For instance, even if a worker is determined as being in the walking state by the detection-data analyzing unit 102 of the location server 100, the determining unit 211 determines that this worker is in the resting state when a magnitude of the walking motion is small and therefore the motion activity level is equal to or lower than the threshold value. Similarly, even if a worker is determined as not being in the walking state by the detection-data analyzing unit 102 of the location server 100, the determining unit 211 determines that this worker is in the moving state when a magnitude of a motion other than the walking motion is large and therefore the motion activity level is higher than the threshold value.

The determining unit 211 may make further determination, about the worker that is determined as being in the resting state, as to whether the worker is in the standing state or in the sitting state based on information about posture contained in the detection result data received by the communication unit 201.

The estimating unit 212 estimates a position where the worker that is determined as being in the moving state by the determining unit 211 will enter the resting state within a predetermined time period. For instance, the estimating unit 212 estimates a position that satisfies both of the following conditions as the position where the worker determined as being in the moving state will enter the resting state within the predetermined time period. The conditions are: the position is within a predetermined distance from the position of the worker determined as being in the moving state by the determining unit 211; and the position is defined in advance as a position where an activity is to be carried out by a worker in the resting state.

More specifically, when the absolute position of the worker contained in the detection result data received by the communication unit 201 is within the predetermined distance from, for instance, a position of a desk assigned to the worker (the worker's seat), the estimating unit 212 estimates that the position of the worker's seat is the position where the worker will enter the resting state within the predetermined time period. Such processing by the estimating unit 212 can be implemented by employing the following configuration, for example. Information associating positions of seats of all the workers that carry out business activities in the room, which is the control target area, with terminal IDs of the smartphones 300 carried by the respective workers is stored in the storage unit 220, for example. A terminal ID of the smartphone 300, from which detection data, based on which detection result data is obtained, is originated, is appended to the detection result data. The detection result data is transmitted to the control server 200 from the location server 100. The worker's seat is located by using the terminal ID. Meanwhile, there can be a case where the room, which is the control target area, has a common space such as a conference space or a lounge space that has a characteristic that an unspecified worker(s) carries out activity in the resting state. In this case, the estimating unit 212 may estimate that a position of the common space is the position where the worker will enter the resting state within the predetermined time period when the absolute position of the worker contained in the detection result data received by the communication unit 201 is within a predetermined distance from the position of the common space.

Alternatively, the estimating unit 212 may estimate the position where the worker in the moving state will enter the resting state within the predetermined time period based on motion histories of the workers in the room. More specifically, each time detection result data is obtained, the estimating unit 212 stores the detection result data in the storage unit 220 for each of the workers carrying out business activities in the room, so that motion histories are accumulated on a worker-by-worker basis in the storage unit 220. When a worker in the room is determined as being in the moving state, the estimating unit 212 determines a traveling direction of the worker from, for instance, a direction (orientation) of the body of the worker. Simultaneously, the estimating unit 212 determines a position where the worker frequently carried out activities in the resting state in the past by consulting the motion history stored in the storage unit 220 or the like. If the position where the worker frequently carried out activities in the past is in the traveling direction of the worker, the estimating unit 212 estimates this position as the position where the worker will enter the resting state within the predetermined time period. The estimating unit 212 may estimate the position where the worker will enter the resting state within the predetermined time period based on a combination of the distance-based estimation and the motion-history-based estimation described above. For instance, if the position where the worker frequently carried out activities in the past is within a predetermined distance from the position of the worker in the moving state, the estimating unit 212 may estimate this position as the position where the worker will enter the resting state within the predetermined time period.

The control unit 213 controls each of the devices (the plurality of LED lighting devices 500, the plurality of electrical outlets 600, and the plurality of air conditioners 700) arranged in the room based on the absolute positions (the absolute positions of the workers in the room, which is the control target area) contained in the detection result data received by the communication unit 201 and the result of the determination made by the determining unit 211. More specifically, the control unit 213 performs control of placing a device corresponding to a position at which no worker is present and a device corresponding to a position at which a worker in the moving state is present in a first state, and placing a device corresponding to a position at which a worker in the resting state is present in a second state that differs from the first state. Moreover, when the position where the worker in the moving state will enter the resting state within the predetermined time period is estimated by the estimating unit 212, the control unit 213 performs control of placing a device corresponding to this position estimated by the estimating unit 212 in the second state.

The first state is a default control state, in which power consumption of the device is reduced to achieve power saving. The second state is a device control state, in which consideration is given to comfort of a worker carrying out a business activity. These first state and second state are defined in advance on a per-type basis of the controlled devices and stored in the storage unit 220 in the form of the control table, for example. The control unit 213 controls each of the controlled devices by consulting this control table as need arises. In the description below, it is assumed that the controlled devices are the LED lighting devices 500, the air conditioners 700, and the PC system units and the display devices plugged into the electrical outlets 600 of the respective desks that are distributed in the room. The control unit 213 controls these controlled devices by transmitting a control signal for bringing a device to the first state or the second state to each of the LED lighting devices 500, the air conditioners 700, the electrical outlets 600, the PC system units, and the display devices.

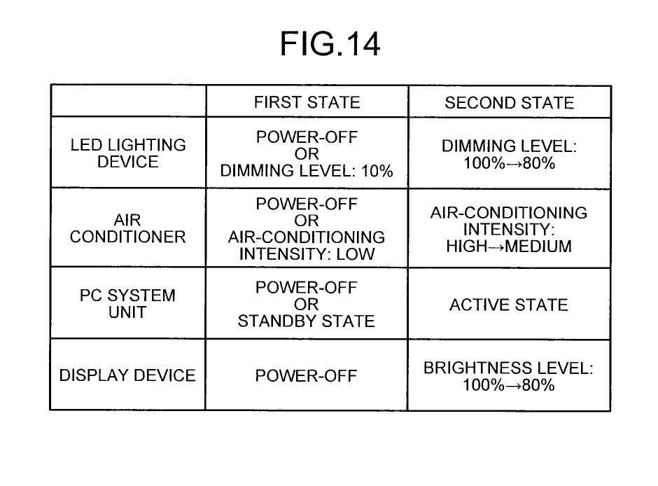

FIG. 14 is a diagram illustrating an example of the control table stored in the storage unit 220. Referring to the control table illustrated in FIG. 14, the first state of the LED lighting devices 500 is defined as a state where the power is off or the dimming level is 10%; and the second state is defined as a state where the dimming level temporarily becomes 100% and thereafter gradually decreases to 80%. The first state of the air conditioners 700 is defined as a state where the power is off or the air-conditioning intensity is “low”; and the second state is defined as a state where the air-conditioning intensity temporarily becomes “high” and thereafter decreases to “medium”. The first state of the PC system units plugged into the electrical outlets 600 is defined as the power-off state or the standby state; and the second state is defined as the active state. The first state of the display devices plugged into the electrical outlets 600 is defined as the power-off state; and the second state is defined as a state where the brightness level temporarily becomes 100% and thereafter gradually decreases to 80%.

The device corresponding to a position at which a worker is present denotes a device arranged near the absolute position of the worker in the room. The control unit 213 can determine the device corresponding to a position at which a worker is present based on the absolute positions contained in the detection result data and the position data about each of the devices (hereinafter, “device position data”) stored in the storage unit 220. The device corresponding to a position at which no worker is present denotes the devices arranged in the room exclusive of the devices each determined as corresponding to a position at which a worker is present.

The device control described above to be performed by the control unit 213 can be implemented as follows, for example. First, the control unit 213 performs control of placing each of the controlled devices in the first state, which is the default control state, at time (e.g., 30 minutes ahead of office starting time) when no worker is present in the room, which is the control target area. Thereafter, when a worker enters the room, which is the control target area, and the location server 100 starts transmitting detection result data to the control server 200, the control unit 213 determines a device corresponding to a position at which the worker is present (device arranged near an absolute position of the worker) based on the absolute position contained in the detection result data and the device position data stored in the storage unit 220. The control unit 213 maintains the determined device in the first state when the determining unit 211 determines that the worker is in the moving state. The control unit 213 causes the determined device to shift from the first state to the second state when the determining unit 211 determines that the worker is in the resting state. When a position where the worker in the moving state will enter the resting state within the predetermined time period is estimated by the estimating unit 212, the control unit 213 causes a device corresponding to this position (device arranged near this position) to shift from the first state to the second state.

The determining unit 211 can make further determination as to whether the worker determined as being in the resting state is in the standing state or in the sitting state. In a case where this determination is made, the control unit 213 may determine whether to maintain the device determined as corresponding to the position at which the worker is present in the first state or cause the device to shift from the first state to the second state depending on whether the worker in the resting state is in the standing state or in the sitting state. More specifically, there may be employed a configuration, in which the control unit 213 maintains at least a part of the determined device in the first state when the determining unit 211 determines that the worker in the resting state is in the standing state, but causes the determined device to shift from the first state to the second state when the determining unit 211 determines that the worker in the resting state is in the sitting state.

Furthermore, the control unit 213 may perform control in the following manner on a device, for which facing relationship with a worker matters much, such as the display device plugged into the electrical outlet 600. That is, the control unit 213 causes such a device to shift from the first state to the second state only when the worker is in the sitting state and a direction of the worker is forward (direction facing the front surface of the display device).

When the worker near the device caused to shift from the first state to the second state has moved to another position, and there is no worker at the position corresponding to this device any more, the control unit 213 causes this device to return from the second state to The first state. After all the workers have exited the room, which is the control target area, the control unit 213 shuts off power supply to the controlled devices, for example. Meanwhile, if the first states defined for the controlled devices are all “power-off”, the process to be performed before a worker enters the room and the process to be performed after all the workers have exited the room described above become unnecessary.

The control unit 213 performs the device control described above on each of detection result data sets, which are transmitted as occasion arises from the location server 100. More specifically, control is performed in the following manner depending on the motions and the positions, which change from moment to moment, of the workers in the room. A device corresponding to a position at which no worker is present is placed in the first state. Even when a device corresponds to a position at which a worker is present, if the worker is in the moving state, the device is placed in the first state. Only a device corresponding to a position at which a worker in the resting state is present is placed in the second state.

Meanwhile, there can be a case where one and same device corresponds to a position, at which a worker in the moving state is present, and a position, at which another worker in the resting state is present. This can occur in a situation where, for instance, one worker passes by a desk in front of which another worker is sitting. In such a case, the control unit 213 puts higher priority on the worker in the resting state and performs control of placing this device in the second state. This is because the worker in the resting state is highly possibly carrying out a business activity at the position, and therefore it is desirable to put higher priority on comfort of the worker in the resting state to prevent decrease in efficiency of the activity.

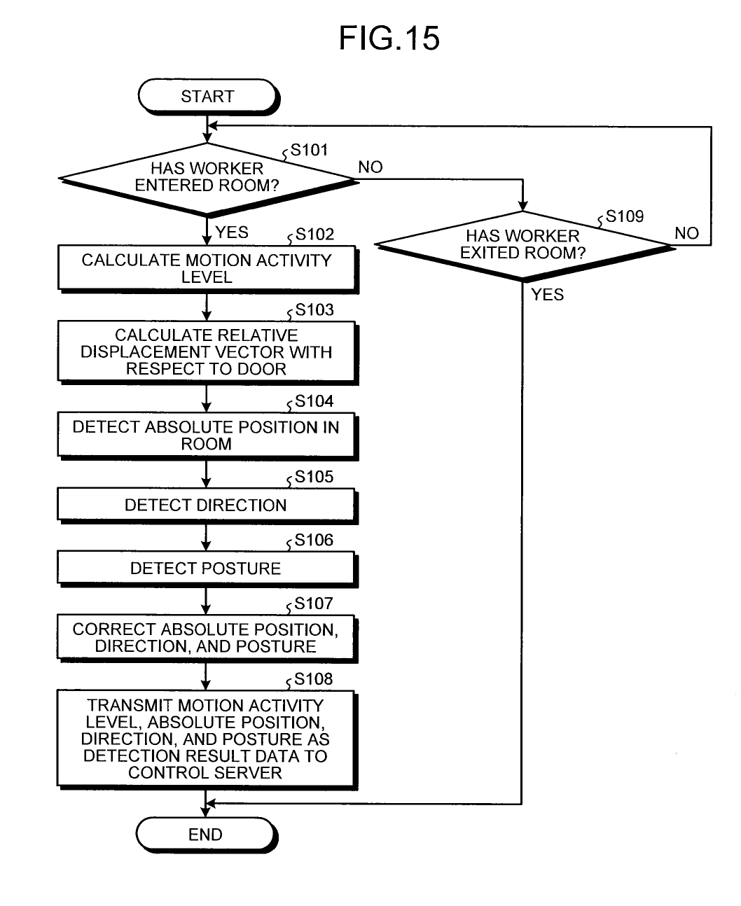

Operations of the device control system of the present embodiment configured as described above are described below. FIG. 15 is a flowchart illustrating an example of a procedure for a process to be performed by the location server 100 of the present embodiment. The process indicated in this flowchart is performed on each of the plurality of smartphones 300.

Aside from the process indicated in this flowchart, the location server 100 receives detection data (acceleration vectors, angular velocity vectors, and magnetic vectors) at fixed time intervals from the acceleration sensors, the angular velocity sensors, and the geomagnetic field sensors mounted on the plurality of smartphone 300 and/or the acceleration sensors, the angular velocity sensors, and the geomagnetic field sensors other than those of the smartphones 300. The location server 100 also receives captured images from the plurality of monitoring cameras 400.

First, the location server 100 determines whether or not a worker has entered the room, which is the control target area, based on captured images of, for example, a door that is opened or closed (Step S101). When a worker has entered the room (Yes in Step S101), the detection-data analyzing unit 102 calculates the motion activity level of the worker based on detection data transmitted as needed from the smartphone 300 carried by the worker entered the room using the method described above (Step S102). When no worker has entered the room (No in Step S101), the location server 100 determines whether or not a worker has exited the room (Step S109). When a worker has exited the room (Yes in Step S109), the process indicated in the flowchart illustrated in FIG. 15 for this worker ends. When neither entry into nor exit from the room is detected (No in Step S109), the process of determining whether a worker has entered or exited the room is repeatedly performed.

Subsequently, the detection-data analyzing unit 102 calculates a relative displacement vector with respect to, for example, the door serving as the reference position using the method described above (Step S103). The detection-data analyzing unit 102 detects an absolute position of the worker based on the map data of the inside of the room stored in the storage unit 110 and the relative displacement vector with respect to the door (Step S104).

Subsequently, the detection-data analyzing unit 102 detects a direction (orientation) of the worker based on a magnetic vector contained in the detection data (Step S105). The detection-data analyzing unit 102 also detects whether the worker is in the sitting state or in the standing state as a posture of the worker using the method described above (Step S106). The detection-data analyzing unit 102 may further detect, as a motion state of the worker, either the squatting motion or the standing motion, either the motion of changing the orientation or the motion of bringing the orientation back in the sitting state, either the motion of turning the worker's eyes up or the motion of turning the eyes back in the sitting state, and either the motion of turning the eyes down or the motion of turning the eyes back in the sitting state.

Subsequently, the correcting unit 103 determines whether the absolute position detected in Step S104, the direction detected in Step S105, and the posture detected in Step S106 require correction as described above, and, if necessary, corrects them (Step S107).

The communication unit 101 then transmits the motion activity level of the worker calculated in Step S102, the absolute position detected in Step S104, the direction detected in Step S105, and the posture detected in Step S106 (in a case where correction is performed in Step S107, the corrected absolute position, and the detected direction and posture) to the control server 200 as detection result data (Step S108).

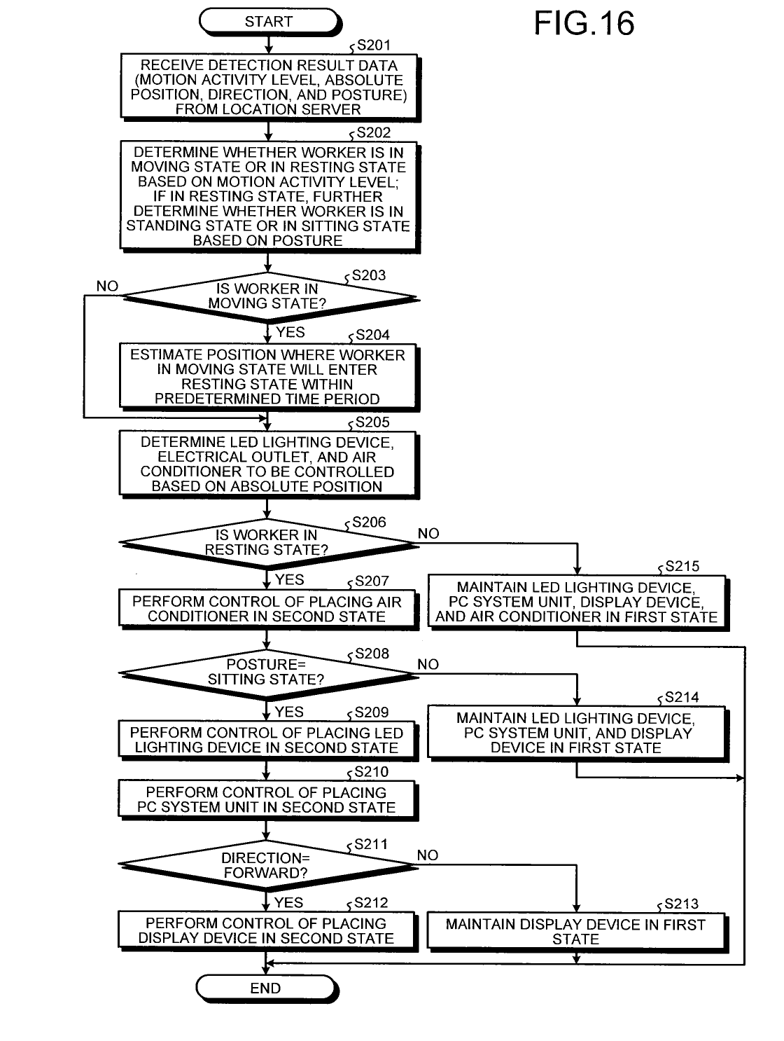

A process to be performed by the control server 200 of the present embodiment is described below. FIG. 16 is a flowchart illustrating an example of a procedure for the process to be performed by the control server 200 of the present embodiment. The process indicated in this flowchart starts when a worker enters the room, which is the control target area, and detection result data is transmitted from the location server 100. The process is performed on each of detection result data sets (i.e., on each of the workers in the room) that are transmitted. It is assumed that the devices in the room have been placed in the first state, which is the default control state, under control of the control server 200 before the process indicated in this flowchart starts.

First, the communication unit 201 receives the detection result data containing the motion activity level, the absolution position, the direction, and the posture of the worker from the location server 100 (Step S201).

Subsequently, the determining unit 211 of the device control unit 210 determines whether the worker is in the moving state or in the resting state based on the motion activity level contained in the detection result data received in Step S201. When the worker is determined as being in the resting state, the determining unit 211 further determines whether the worker in the resting state is in the standing state or in the sitting state based on the posture contained in the detection result data (Step S202). More specifically, the determining unit 211 compares the motion activity level contained in the detection result data against the preset threshold value as described above. The determining unit 211 determines that the worker is in the moving state if the motion activity level is higher than the threshold value, but determines that the worker is in the resting state if the motion activity level is equal to or lower than the threshold value. The determining unit 211 further determines, when the worker is determined as being in the resting state, whether the worker is in the standing state or in the sitting state based on the posture contained in the detection result data.

Subsequently, the estimating unit 212 refers to the result of determination made by the determining unit 211 in Step S202 (Step S203). When the worker is in the moving state (Yes in Step S203), the estimating unit 212 estimates a position where the worker in the moving state will enter the resting state within the predetermined time period using the method described above (Step S204). When the worker is in the resting state (No in Step S203), Step S204 is skipped.

Subsequently, the control unit 213 determines one of the LED lighting devices 500, one of the electrical outlets 600 (a PC system unit and a display device plugged into the one electrical outlet 600), and one of the air conditioners 700, which are devices to be controlled (hereinafter, “controlled devices”), based on the absolute position contained in the detection result data received in Step S201 (Step S205). More specifically, the control unit 213 consults the device position data stored in the storage unit 220 to determine the one LED lighting device 500 arranged near the absolute position contained in the detection result data, the one electrical outlet 600 arranged near the absolute position, the PC system unit and the display device plugged into this electrical outlet 600, and the one air conditioner 700 arranged near the absolute position as the controlled devices.

Subsequently, the control unit 213 refers to the result of determination made by the determining unit 211 in Step S202 (Step S206). When the worker is in the resting state (Yes in Step S206), the control unit 213 performs control of placing the one air conditioner 700 determined as the controlled device in Step S205 in the second state (Step S206).

Subsequently, the control unit 213 refers to the result of determination made by the determining unit 211 in Step S202 (Step S208). When the worker in the resting state is in the sitting state (Yes in Step S208), the control unit 213 performs control of placing the one air conditioner 700 determined as the controlled device in Step S205 in the second state (Step S209). The control unit 213 further performs control of placing the PC system unit determined as the controlled device in Step S205 in the second state (Step S210).

Subsequently, the control unit 213 determines whether or not the direction of the worker is forward (the direction in which the worker faces the front surface of the display device determined as the controlled device in Step S205) based on the direction contained in the detection result data received in Step S201 (Step S211). When the direction of the worker is forward (Yes in Step S211), the control unit 213 performs control of placing the display device determined as the controlled device in Step S205 in the second state (Step S212). On the other hand, when the direction of the worker is not forward (No in Step S211), the control unit 213 maintains the display device determined as the controlled device in Step S205 in the first state, which is the default control state (Step S213).

When the control unit 213 finds that the worker in the resting state is in the standing state from the result of determination made by the determining unit 211 in Step S208 (No in Step S208), the control unit 213 maintains the one LED lighting device 500, the PC system unit, and the display device that are determined as the controlled devices in Step S205 in the first state, which is the default control state (Step S214).

When the control unit 213 finds that the worker is in the moving state from the result of determination made by the determining unit 211 in Step S206 (No in Step S206), the control unit 213 maintains the one air conditioner 700, the one LED lighting device 500, the PC system unit, and the display device that are determined as the controlled devices in Step S205 in the first state, which is the default control state (Step S215). At this time, when the estimating unit 212 has estimated a position in Step S203, or, more specifically, when the estimating unit 212 has estimated the position where the worker in the moving state will enter the resting state within the predetermined time period, the control unit 213 performs control of placing one of the LED lighting devices 500, one of the electrical outlets (a PC system unit and a display device plugged into the one electrical outlet 600), and one of the air conditioners 700 arranged near this position estimated by the estimating unit 212 in the second state.

Note that the process performed by the control server 200 described above is only an example, and the control unit 213 may perform the process on other device than the controlled devices described above. The control unit 213 may be configured to perform other control operations than those described above on the controlled devices. For instance, the control unit 213 may be configured so as to control the controlled devices differently depending on a motion state of the worker. The motion state can be: either the squatting motion or the standing motion; either the motion changing the orientation or the motion of bringing the orientation back in the sitting state; either the motion (looking-up motion) of turning the worker's eyes up or the motion of turning the eyes back in the sitting state; and either the motion (looking-down motion) of turning the eyes down or the motion of turning the eyes back in the sitting state.

Specific examples of the motions, the controlled device, and a control method for such a configuration are described below. Each of these motions is a motion that can occur when a worker is assumed to be sitting in front of a desk. Examples of the controlled device include a PC system unit, a display device, a desk lamp, and a desk fan as an individual air conditioner.

For example, in a situation where a worker is at a desk, when it is determined that a squatting motion of the worker lasts for a predetermined time period or longer based on received detection result data, the control unit 213 may perform control of switching off a socket, into which the PC system unit is plugged, or may perform control of causing the PC system unit to shift to the standby state. When the standing state lasts for a predetermined time period or longer after the standing motion is detected in a worker in the sitting state, the control unit 213 may perform control of causing the PC system unit to shift to the standby state and, simultaneously, powering off the display device.

Examples of control to be performed in response to an orientation-changing motion of a worker include the following. When, after a change in orientation of a head or an upper body is detected in a worker sitting in front of a desk, this state lasts for a predetermined time period or longer, the worker is likely to be making conversation with another worker at an adjacent desk or the like. In such a situation, the control unit 213 may perform control in the following manner. That is, the control unit 213 brings the PC system unit, the display device, the desk lamp, and the like to the standby state or powers them off; when it is detected the worker's orientation and posture have returned to their previous states, the control unit 213 powers on the PC system unit, the display device, the desk lamp, and the like.

A worker that reads a document at a desk is likely to perform the looking-down motion. A worker that is trying to come up with an idea or thinking is likely to perform the looking-up motion. Accordingly, the control unit 213 may perform control of causing the PC system unit to shift to the standby state or switching off the display device when the looking-up motion or the looking-down motion is continuously detected for a predetermined time period or longer. Moreover, the control unit 213 may perform control of not switching off the desk lamp when the detected motion is the looking-down motion.

As described above in detail by way of specific examples, according to the present embodiment, the determining unit 211 of the device control unit 210 of the control server 200 determines whether a worker is in the moving state or in the resting state based on the motion activity level of the worker contained in detection result data transmitted from the location server 100. When the worker is in the moving state, the control unit 213 performs control of placing a device arranged near a position where the worker is present in the first state, which is the default control state, as in the case of a device at a position at which no worker is present. When the worker is in the resting state, the control unit 213 performs control of placing a device arranged near a position where the worker is present in the second state, in which consideration is given to comfort of the worker. Accordingly, according to the present embodiment, it is possible to achieve power saving and increase comfort while effectively obviating inconvenience of giving discomfort to a worker making a large motion due to delay in device control in response to a change in position of the worker.

The conventional technique of detecting a position of a person and controlling a device according to the detected position of the person is disadvantageous in that it is difficult to control the device in a manner that the device quickly responds to a person making a large motion. As a result, delay in control gives discomfort to the person in some cases. In contrast, according to the present embodiment, control is performed as follows. A device arranged near a position at which a worker making a large motion is present is placed in the first state, which is the default control state, as in the case of a device at a position at which no worker is present. Only a device arranged near a position at which a worker making a small motion is present is placed in the second state. Accordingly, because delay in control in response to a motion of a worker can be ostensibly eliminated, power saving and increasing comfort can be achieved while reducing discomfort given to a worker making a large motion.

According to the present embodiment, the determining unit 211 further makes determination as to whether the worker determined as being in the resting state is in the standing state or in the sitting state. The control unit 213 performs control of placing at least a part of the device, even if the device is near the position at which the worker in the resting state is present, in the first state if the worker is in the standing state, but placing the device near the position at which the worker in the sitting state is present in the second state. As a result, further power saving can be achieved. In short, because a guess can be made that a worker in the standing state is not carrying out a business activity, further power saving can be achieved by applying control that gives a higher priority to power saving than to comfort to a device near such a worker.

According to the present embodiment, the estimating unit 212 estimates a position where a worker in the moving state will enter the resting state within the predetermined time period. The control unit 213 performs control of placing a device corresponding to this position estimated by the estimating unit 212 in the second state. As a result, comfort of the worker can be further increased. In short, control is performed to place the device near the position where the worker in the moving state is estimated to enter the resting state to carry out a business activity within the predetermined time period in the second state in advance. As a result, a comfort working environment can be provided to the worker immediately when the worker reaches the position, whereby comfort of the worker can be further increased.

Each of the location server 100 and the control server 200 according to the present embodiment has a hardware configuration implemented in a typical computer and includes a control device such as a central processing unit (CPU), a storage device such as a read only memory (ROM) and a random access memory (RAM), an external storage such as an HDD and/or a compact disk (CD) drive, a display device, and an input device such as a keyboard and/or a mouse.

Detection program to be executed by the location server 100 of the embodiment and control program to be executed by the control server 200 of the embodiment are each provided as a computer program product stored in a non-transitory tangible computer-readable storage medium as a file in an installable format or an executable format. The computer-readable storage medium can be, for instance, a CD-ROM, a flexible disk (FD), a CD-R, or a digital versatile disk (DVD).

Each of the detection program to be executed by the location server 100 of the embodiment and the control program to be executed by the control server 200 of the embodiment may be configured to be stored in a computer connected to a network, such as the Internet, and provided by downloading over the network. Each of the detection program to be executed by the location server 100 of the embodiment and the control program to be executed by the control server 200 of the embodiment may be configured to be provided or distributed via a network, such as the Internet.

Each of the detection program to be executed by the location server 100 of the embodiment and the control program to be executed by the control server 200 of the embodiment may be configured to be provided as being installed on a ROM or the like in advance.

The detection program to be executed by the location server 100 of the present embodiment has a module structure including the units (the communication unit 101, the detection-data analyzing unit 102, and the correcting unit 103) described above. From viewpoint of actual hardware, the CPU (processor) reads out the detection program from the storage medium and executes the program to load the units on a main memory device, thereby generating the communication unit 101, the detection-data analyzing unit 102, and the correcting unit 103 on the main memory device.

The control program to be executed by the control server 200 of the present embodiment has a module structure including the units (the communication unit 201, the power-consumption managing unit 202, and the device control unit 210 (the determining unit 211, the estimating unit 212, and the control unit 213)) described above. From viewpoint of actual hardware, the CPU (processor) reads out the control program from the storage medium and executes the program to load the units on a main memory device, thereby generating the communication unit 201, the power-consumption managing unit 202, and the device control unit 210 (the determining unit 211, the estimating unit 212, and the control unit 213) on the main memory device.

For instance, the embodiment described above is an example, in which the location server 100 and the control server 200 are embodied in apparatuses independent of each other. Alternatively, functions of the location server 100 and the control server 200 may be embodied in a single apparatus. More specifically, in the embodiment described above, detection data output from the acceleration sensor, the angular velocity sensor, and the geomagnetic field sensor is transmitted from the smartphone 300 and received by the location server 100. The location server 100 detects the motion activity level, the absolution position, the direction, the posture, and the like of the worker based on the detection data. Alternatively, there may be employed a configuration, in which the control server 200 receives detection data output from the sensors from the smartphone 300 and detects the motion activity level, the absolution position, the direction, the posture, and the like of the worker based on the received detection data.

There may be employed a configuration, in which the functions of the location server 100 of the embodiment described above are offloaded to the smartphone 300. More specifically, there may be employed the following configuration. That is, map data of the room, which is the control target area, is stored in the smartphone 300. The smartphone 300 detects the motion activity level, the absolution position, the direction, the posture, and the like of the worker based on detection data output from the sensors, and transmits detection result data containing these information sets to the control server 200.

According to an aspect of the present invention, power saving and increasing comfort can be achieved while reducing discomfort given to a worker making a large motion.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. An environment control system for automatically controlling a space environment with an electric facility according to a location and a motion of a human being in a given space, the environment control system comprising:
a positioning system; and
an electric facility control system communicated with the positioning system,
the positioning system comprising:
at least one sensor configured to detect the location and the motion of the human being; and
an operation unit communicated with the at least one sensor and configured to compute, based on the detection result from the at least one sensor, at least a value representing an absolute location of the human being from a reference point, a value representing a motion activity indicating a degree of the motion, and a value representing posture of the human being, and configured to transmit the computed values to the electric facility control system,
the electric facility control system comprising:
a determining unit configured to receive a signal from the operation unit, to compare the value of the motion activity with a predetermined threshold value and to determine that the human being in the given space is in a moving state if the value of the motion activity of the human being is higher than the predetermined threshold value, and to determine that the human being in the given space is in a resting state if the value of the motion activity of the human being is equal to or lower than the predetermined threshold value; and
a controller communicated with the determining unit and configured to control the electric facility to change, according to the result of the determination, the environment of the given space containing the absolute position, wherein
the operation unit performs the operation based on the detection result from the at least one sensor associated with a body of the human being, and
the operation unit computes the value of the motion activity based on the operation result.

2. The environment control system set forth in claim 1, wherein
if the human being is in the resting state, the determining unit further determines whether the human being is in a standing state or in a sitting state based on the value of posture of the human being, and
when the human being is in the standing state, the controller controls the electric facility present in the given space in the first state, and when the human being is in the sitting state, the controller controls the electric facility present in the given space in the second state different from the first state.

3. The environment control system set forth in claim 1, wherein
the electric facility control system further comprises an estimating unit connected to the determining unit and the controller, and configured to estimate the absolute position where the human being in the moving state comes to the resting state, and
the controller controls the electric facility associated with the given space containing the absolute position in the second state.

4. The environment control system set forth in claim 3, wherein the estimating unit estimates the absolute position where the human being is to be at work as the absolute position where the human being in the moving state comes to the resting state.

5. The environment control system set forth in claim 3, wherein
the electric facility control system further comprises a history storage unit that stores motion history of the human being in the given space, and
the estimating unit estimates the absolute position where the human being in the moving state comes to the resting state based on the motion history.

6. The environment control system set forth in claim 1, wherein if the electric facility present in the given space containing the absolute position where the human being is in the moving state is identical to the electric facility present in the given space containing the absolute position where the human being is in the resting state, the controller controls the electric facility in the second state.

7. The environment control system set forth in claim 1, wherein the operation includes a vector operation based on a movement amount of the body of the human being in a horizontal direction.

8. The environment control system set forth in claim 1, wherein the operation includes a vector operation based on a movement amount of the body of the human being in a vertical direction.

9. The environment control system set forth in claim 1, wherein the operation includes a vector operation based on a change amount of orientation of the body of the human being in a horizontal direction.

10. The environment control system set forth in claim 1, wherein the at least one sensor associated with the body of the human being is carried by the human being and comprises an acceleration sensor, an angular velocity sensor, and a geomagnetic field sensor.

11. The environment control system set forth in claim 1, wherein the at least one sensor includes at least one monitoring camera that monitors the given space.

12. An electric facility control system configuring the environment control system set forth in claim 1.

13. A method for performing an environment control system for automatically controlling a space environment with an electric facility according to a location and a motion of a human being in a given space, the environment control system comprising:
a positioning system; and
an electric facility control system communicated with the positioning system,
the positioning system comprising:
at least one sensor configured to detect the location and the motion of the human being; and
an operation unit communicated with the at least one sensor and configured to compute, based on the detection result from the at least one sensor, at least a value representing an absolute location of the human being from a reference point, a value representing a motion activity indicating a degree of the motion, and a value representing posture of the human being, and configured to transmit the computed values to the electric facility control system,
the electric facility control system comprising:
a determining unit configured to receive a signal from the operation unit, to compare the value of the motion activity with a predetermined threshold value and to determine that the human being in the given space is in a moving state if the value of the motion activity of the human being is higher than the predetermined threshold value, and to determine that the human being in the given space is in a resting state if the value of the motion activity of the human being is equal to or lower than the predetermined threshold value; and
a controller communicated with the determining unit and configured to control the electric facility to change, according to the result of the determination, the environment of the given space containing the absolute position,
the method comprising:
by the operation unit, performing the operation based on the detection result from the at least one sensor associated with the body of the human being, and computing the value of the motion activity based on the operation result;
by the determining unit, comparing the value of the motion activity with the predetermined threshold value and determining that the human being in the given space is in a moving state if the value of the motion activity of the human being is higher than the predetermined threshold value, and determining that the human being in the given space is in a resting state if the value of the motion activity of the human being is equal to or lower than the predetermined threshold value; and
by the controller, controlling the electric facility to change, according to the result of the determination, the environment of the given space containing the absolute position.

14. A computer readable medium including a computer program product, the computer program product comprising instructions which, when caused by a computer, causes the computer to perform operations for performing an environment control system for automatically controlling a space environment with an electric facility according to a location and a motion of a human being in a given space, the environment control system comprising:
a positioning system; and
an electric facility control system communicated with the positioning system,
the positioning system comprising:
at least one sensor configured to detect the location and the motion of the human being; and
an operation unit communicated with the at least one sensor and configured to compute, based on the detection result from the at least one sensor, at least a value representing an absolute location of the human being from a reference point, a value representing a motion activity indicating a degree of the motion, and a value representing posture of the human being, and configured to transmit the computed values to the electric facility control system,
the electric facility control system comprising:
a determining unit configured to receive a signal from the operation unit, to compare the value of the motion activity with a predetermined threshold value and to determine that the human being in the given space is in a moving state if the value of the motion activity of the human being is higher than the predetermined threshold value, and to determine that the human being in the given space is in a resting state if the value of the motion activity of the human being is equal to or lower than the predetermined threshold value; and
a controller communicated with the determining unit and configured to control the electric facility to change, according to the result of the determination, the environment of the given space containing the absolute position,
the operations comprising:
by the operation unit, performing the operation based on the detection result from the at least one sensor associated with the body of the human being, and computing the value of the motion activity based on the operation result;
by the determining unit, comparing the value of the motion activity with the predetermined threshold value and determining that the human being in the given space is in a moving state if the value of the motion activity of the human being is higher than the predetermined threshold value, and determining that the human being in the given space is in a resting state if the value of the motion activity of the human being is equal to or lower than the predetermined threshold value; and
by the controller, controlling the electric facility to change, according to the result of the determination, the environment of the given space containing the absolute position.
